(19) United States
(12) Patent Application Publication
(10) Pub. No.: US 2009/0059840 A1
(43) Pub. Date: Mar. 5, 2009

(54) Wireless communication system and method for managing service flow identifier in the same

(75) Inventors: Jung-Mo Moon, Daejeon-city (KR); Mi-Young Yun, Daejeon-city (KR); Sang-Ho Lee, Daejeon-city (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Electronics and Telecommunications Research Institute, Daejeon (KR); KT Corporation, Seongnam-city (KR); SK TELECOM CO., LTD, Seoul (KR); HANARO TELECOM., INC., Seoul (KR)

(21) Appl. No.: 11/635,717

(22) Filed: Dec. 7, 2006

(30) Foreign Application Priority Data
Dec. 8, 2005 (KR) 10-2005-0120140

(51) Int. Cl. H04Q 7/00

(52) U.S. Cl. 370/328

(57) ABSTRACT

The present invention relates to a wireless communication system and a service flow identifier management method thereof. The wireless communication system includes a plurality of RASs for controlling a plurality of PSSs in a radio network, and a plurality of ACRs for providing wireless communication services to the PSSs through the plurality of RASs, and respectively managing a service flow identifier used for identifying a connection service for each PSS. When a status of each service flow identifier managed by the plurality of ACRs is different, the wireless communication system releases the corresponding service flow identifier so as to set the status of each of the service flow identifiers to be the same. According to the present invention, in the wireless communication system, the plurality of ACRs separately manage service flow identifiers, and mismatched service flow identifier information due to errors in the system or a node or message transmission/receiving errors can be set to be the same. In addition, when a partial system error occurs and thus the system is restored, a service flow identifier not having the same status due to the error can be efficiently released and set to be the same.

### PRIORITY

This application claims priority under 35 U.S.C. §119 to a Korean application filed in the Korean Intellectual Property office on Dec. 8, 2005 and allocated Serial No. 10-2005-0120140, the contents of which are incorporated herein by reference.

### BACKGROUND OF THE INVENTION

(a) Field of the Invention

The present invention relates to a service flow identifier management method, and it more particularly relates to an apparatus for managing a service flow identifier in a wireless communication system, and a method thereof.

(b) Description of the Related Art

A broadband wireless access (BWA) system that supports a portable Internet (e.g., WiBro) or IEEE 802.16 provides Internet services with various levels of quality of service (QoS) to a user with low speed mobility. Such a system uses a connection identifier and a service flow identifier to transmit a control message and user data between a mobile station and a base station. The connection identifier is an identifier uniquely allocated to each connection in one base station.

The mobile terminal and the base station determine a destination of a packet based on the connection identifier of a received packet in a radio network.

When the mobile station performs handoff while receiving a service from a current base station to a new base station, the new base station generates a new connection identifier for the corresponding mobile station terminal and allocates the new connection identifier to the mobile station.

A service flow identifier is generated by a service flow identifier managing server upon a service request of the mobile station and is not changed when the mobile station performs handoff. The service flow identifier can be used as a unique identifier for determining a connection service of the mobile station. Such a service flow identifier is generated by a connection generation message and is deleted by a connection release message transmitted from the mobile terminal.

A service flow identifier and a connection identifier have a 1:1 or 1:0 relationship. An access control router (ACR) controls a base station in a typical wireless communication system and sets a quality of service (QoS) parameter set of dynamic service-related messages to a provision set when generating or changing a connection in a portable Internet system. In this case, a service flow identifier is allocated for the connection but a connection identifier is not allocated. However, when a connection between a service flow identifier and a connection identifier corresponds to an admitted set or an active set, the connection is allocated with resources including radio resources as well as a connection identifier.

As described above, the service flow identifier is a unique identifier that can determine connection establishment of one mobile station in one service provider network, and therefore it needs to be separately managed. Conventionally, a service flow identifier is managed by a centralized method.

According to the centralized method, one service flow identifier managing server is provided in a network for managing all service flow identifiers. Therefore, the mobile station requests a service flow identifier from the service flow identifier managing server when establishing a connection with each base station, and requests service flow identifier deletion from the server when releasing the connection.

Although the centralized service flow identifier managing method can efficiently manage service flow identifiers, the number of control messages transmitted for service flow identifier management is increased and an error in one service flow identifier managing server may affect the overall system.

### SUMMARY OF THE INVENTION

The present invention has been made in an effort to provide a wireless communication system having advantages of separately managing service flow identifiers and setting information of each of service flow identifiers to be the same when each service flow identifier has different information due to a system error or an information loss so as to prevent duplicated allocation of resources or prevent occurrence of an error in use of the resources, and a service flow identifier management method thereof.

An exemplary wireless communication system according to one embodiment of the present invention includes a plurality of radio access routers (RASs) for controlling a plurality of portable subscriber stations (PSSs) in a radio network, and a plurality of access control routers (ACRs) for providing wireless communication services to the PSSs through the plurality of RASs, and it manages a respective service flow identifier used for identifying a connection service for each PSS. When the status of each service flow identifier managed by the plurality of ACRs is different, the wireless communication system releases the corresponding service flow identifier so as to set the status of each service flow identifier to be the same.

An exemplary method according to another embodiment of the present invention manages a service flow identifier. The method includes, when a home ACR that provides wireless communication services to a PSS through a RAS is initialized, determining whether the home ACR is restarted in an error state, and deleting a service flow identifier of a PSS located in a service area of the home ACR when the ACR is restarted in the error state. The service flow identifier is used for identifying a connection service for a PSS.

An exemplary method according to another embodiment of the present invention manages a service flow identifier. The method includes receiving, by a home ACR, a request for releasing a service flow identifier allocated by another ACR, the ACR providing wireless communication services to a PSS through a RAS, setting a response waiting timer to which response waiting time can be set, storing information on a service flow identifier allocated by the another ACR, and requesting release of the service flow identifier from the other ACR.

An exemplary method according to another embodiment of the present invention manages a service flow identifier. The method includes receiving, by a home ACR, a deregistration request from a PSS, the ACR providing wireless communication services to the PSS through a RAS, setting a response waiting timer to which response waiting time can be set, storing information on a service flow identifier of the PSS, and requesting release of the service flow identifier from another ACR allocating the service flow identifier of the PSS.

### BRIEF DESCRIPTION OF THE DRAWINGS

FIG. 1 schematically shows a wireless communication system according to an exemplary embodiment of the present invention.

FIG. 2 is a block diagram of an access control block (ACR) of FIG. 1.

FIG. 3 is a configuration diagram of a service flow identifier used in the wireless communication system according to the exemplary embodiment of the present invention.

FIG. 4A is a schematic diagram of a home identifier table of a table storage unit of FIG. 2.

FIG. 4B is a schematic diagram of a visitor identifier table of the table storage unit of FIG. 2.

FIG. 4C is a schematic diagram of an inactivated node table of the table storage unit of FIG. 2.

FIG. 4D is a schematic diagram of a transaction table of the table storage unit of FIG. 2.

FIG. 5 is a flowchart of a service flow identifier management process when an ACR of the wireless communication system is initialized according to the exemplary embodiment of the present invention.

FIG. 6A is a flowchart of a process for generating and allocating a service flow identifier in the wireless communication system according to the exemplary embodiment of the present invention.

FIG. 6B is a flowchart of a completion process of service flow identifier allocation in the wireless communication system according to the exemplary embodiment of the present invention.

FIG. 7 is a flowchart of a service flow identifier deletion process in the wireless communication system according to an exemplary embodiment of the present invention.

FIG. 8 is a flowchart of service flow identifier deletion in a deregistration process in the wireless communication system according to the exemplary embodiment of the present invention.

FIG. 9 is a flowchart of a service flow identifier deletion process upon a request of another ACR in the wireless communication system according to the exemplary embodiment of the present invention.

FIG. 10 is a flowchart of a service flow identifier management process according to termination of a response waiting timer in the wireless communication system according to the exemplary embodiment of the present invention.

FIG. 11 is a flowchart of a service flow identifier management process when a response message for a service flow identifier release request is received in the wireless communication system according to the exemplary embodiment of the present invention.

FIG. 12 is a flowchart of a service flow identifier management process when a period timer is terminated in the wireless communication system according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

An exemplary embodiment of the present invention will be described in further detail with reference to the accompanying drawings.

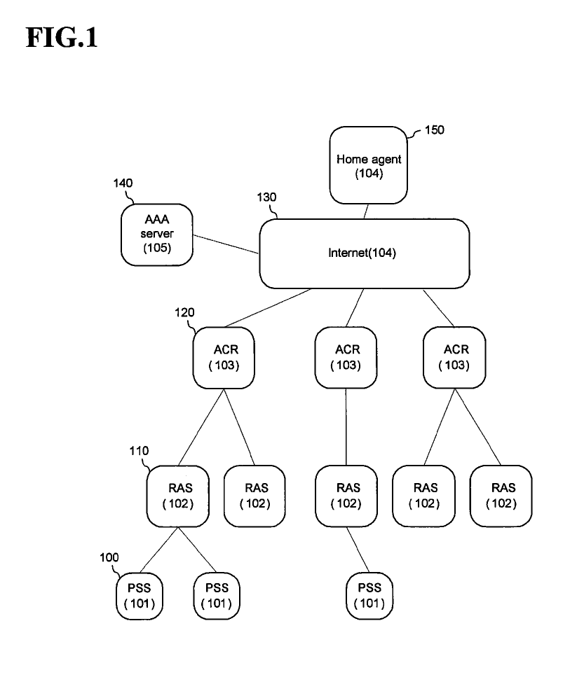

FIG. 1 is a schematic diagram of a wireless communication system according to an exemplary embodiment of the present invention.

As shown in FIG. 1, the wireless communication system to which a service flow identifier controller according to the present invention is applied is provided as a portable Internet system.

The portable Internet system includes a plurality of portable subscriber stations (PSSs) 100, a plurality of radio access stations (RASs) 110, a plurality of RAS controllers 120, an Internet 130, and an authentication, authorization, and accounting (AAA) server 140, and a home agent (HA) 150 for managing IP mobility. The RAS controller 120 will be referred to as an access control router (ACR) 120.

The PSS 100 installs an application program therein, and receives a desired packet service while moving between cells in a currently-serving RAS 110, between the plurality of RASs 110, and between the plurality of ACRs 120.

The RAS 110 is located in a dense metropolitan area and controls and manages a plurality of PSSs 100 in a radio network of a corresponding location.

The ACR 120 is connected to the HA 150 and the AAA server 140 through the Internet 130, and is configured in a hierarchical structure for managing the plurality of RASs 110 in a centralized manner. In addition, the ACR 120 controls radio resource states of a plurality of cells and controls call admission for providing quality of service (QoS).

The AAA server 140 accesses the ACR 120 through the Internet 130, and provides a user authentication function for a corresponding service by using a specific authentication protocol.

The HA 150 accesses the ACR 120 through the Internet 130, and manages IP mobility of the PSS 100 so that the PSS can receive a packet service while moving.

The ACRs 120 distributely manage the generation/deletion of a service flow identifier and manage a state of a service flow identifier in one service provider network.

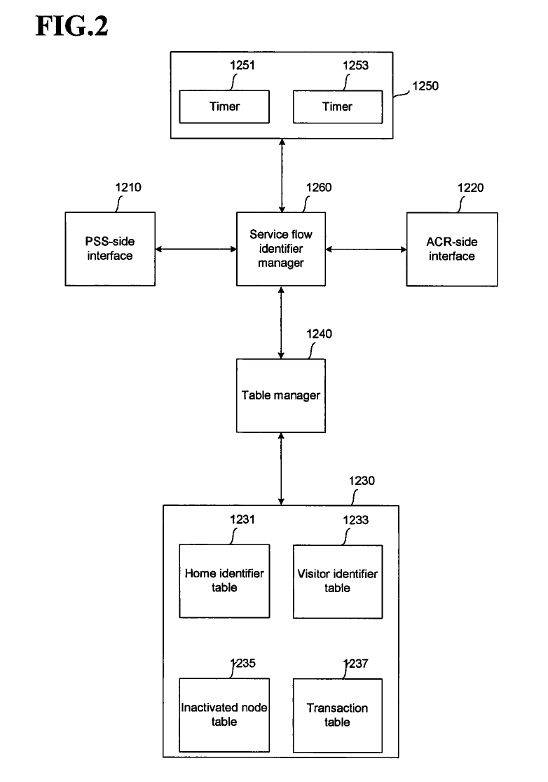

FIG. 2 is a block diagram of the ACR of FIG. 1.

As shown in FIG. 2, the ACR 120 according to the exemplary embodiment of the present invention includes a PSS-side interface 1210, an ACR-side interface 1220, a table storage unit 1230, a table manager 1240, a timer 1250, and a service flow identifier manager 1260.

The PSS-side interface 1210 provides the PSS 100 with an interface for transmitting/receiving a message for controlling a service flow identifier to/from the RAS 110.

The ACR-side interface 1220 provides the ACR 120 with an interface for transmitting/receiving a message for controlling service flow identifiers of PSSs 100 that have performed handoff between ACRs to/from another ACR.

The table storage unit 1230 stores tables used by the ACR 120 for separately managing service flow identifiers. The table storage unit 1230 includes a home identifier table 1231, a visitor identifier table 1233, an inactivated node table 1235, and a transaction table 1237.

The home identifier table 1231 stores a service flow identifier generated by an ACR 120 where the home identifier table 1231 is included.

The visitor identifier table 1233 stores a service flow identifier generated by another ACR 120. The visitor identifier table 1233 stores a service flow identifier of a PSS 100 that visits the ACR 120 by performing handoff from the other ACR 120. Herein, the service flow identifier of the PSS 100 has been generated by the other ACR 120.

An ACR 120 that has generated a service flow identifier stored in the visitor identifier table 1233 may be requested to release the service flow identifier, and the ACR 120 may not transmit a response for the request. In this case, the ACR 120 is determined to be a node in an error state, and the inactivated node table 1235 manages such an error status node.

When a request for releasing a service flow identifier stored in the visitor identifier table 1233 is transmitted to a corresponding ACR 120 that has generated the release-requested service flow identifier, information is transmitted to the ACR 120 and the transaction table 1237 manages the information transmitted to the corresponding ACR 120.

The table manager 1240 manages tables stored in the table storage unit 1230 to generate or delete a service flow identifier or change a status of the service flow identifier.

The timer 1250 measures a variety of time periods used for setting information to each of the separately managed service flow identifiers to be the same. Such a timer 1250 includes a period timer 1251 and a response waiting timer 1253. Each of service flow identifiers that are separately managed between ACRs may have different information due to a system error so that the period timer 1251 measures time for periodically setting information of each of the service flow identifiers to be the same. The response waiting timer 1253 measures time taken for determining an ACR 120 that has received a request for releasing a service flow identifier generated by the ACR 120 to be an error status node when a response is not received from the ACR 120.

The service flow identifier manager 1260 communicates messages with the PSS 100 through the PSS-side interface 1210, communicates messages with another ACR 120 through the ACR-side interface 1220, generates/manages/deletes a service flow identifier by using the table manager 1240, and measures time used for deleting a service flow identifier having different information so as to set information of each service flow identifier to be the same.

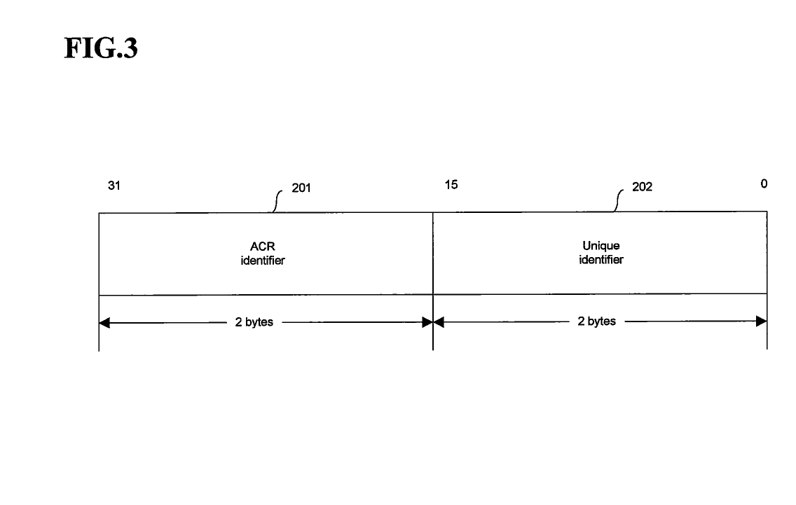

FIG. 3 is a configuration diagram of a service flow identifier used in the wireless communication system according to the exemplary embodiment of the present invention.

As shown in FIG. 3, the wireless communication apparatus according to the exemplary embodiment of the present invention uses a service flow identifier having a length of 4 bytes.

The two most significant bytes among the 4-byte service flow identifier are used for an ACR identifier 201 to identify an ACR 120 that has generated the corresponding service flow identifier, and the two least significant bytes are used for a unique identifier 202 to identify a unique value in the ACR 120 at the time that the ACR 120 generates the corresponding service flow identifier. That is, the service flow is formed of the ACR identifier 201 and the unique identifier 202, and the ACR identifier 201 is used to select a table for storing and managing the service flow identifier among the home identifier table 1231 and the visitor identifier table 1233.

When service flow identifiers are allocated by one ACR 120, the allocated service flow identifiers respectively have the same ACR identifier 201 and respectively have a different unique identifier 202 within a range of 0 to 65535.

Therefore, a service flow identifier has a unique value within one service provider network in a separate processing environment. In addition, an ACR 120 that has generated each service flow identifier can be identified with reference to an ACR identifier 201 of the corresponding service flow identifier.

The ACR 120 manages service flow identifiers by separating them into a home identifier table 1231 and a visitor identifier table 1233.

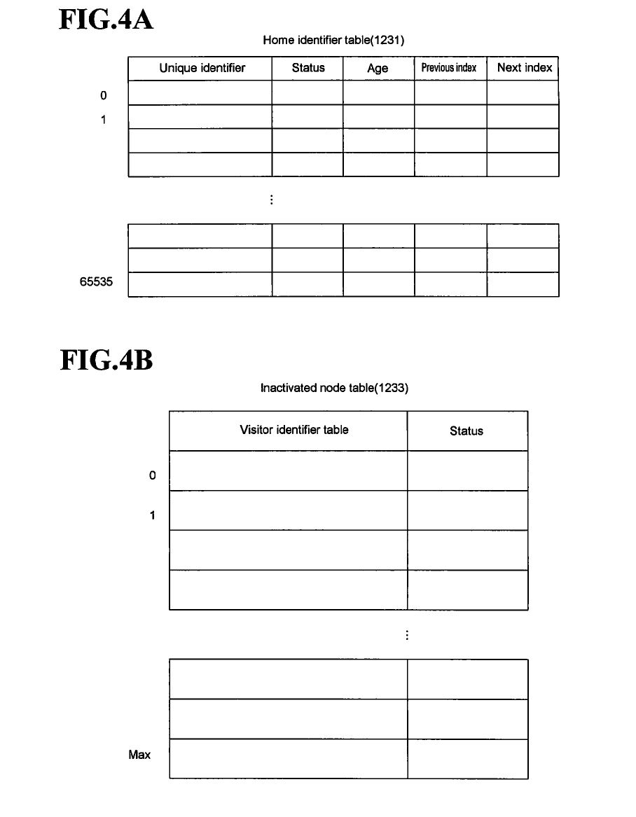

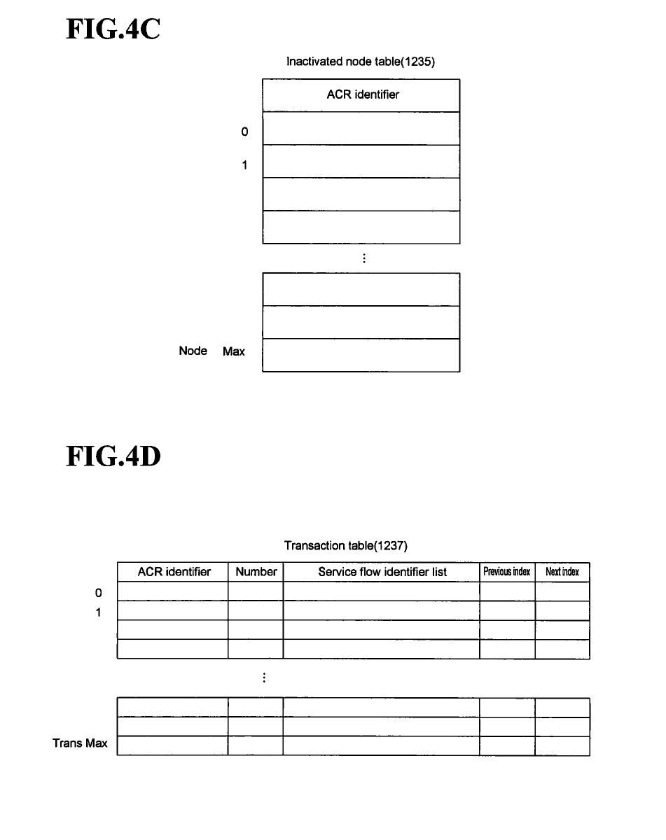

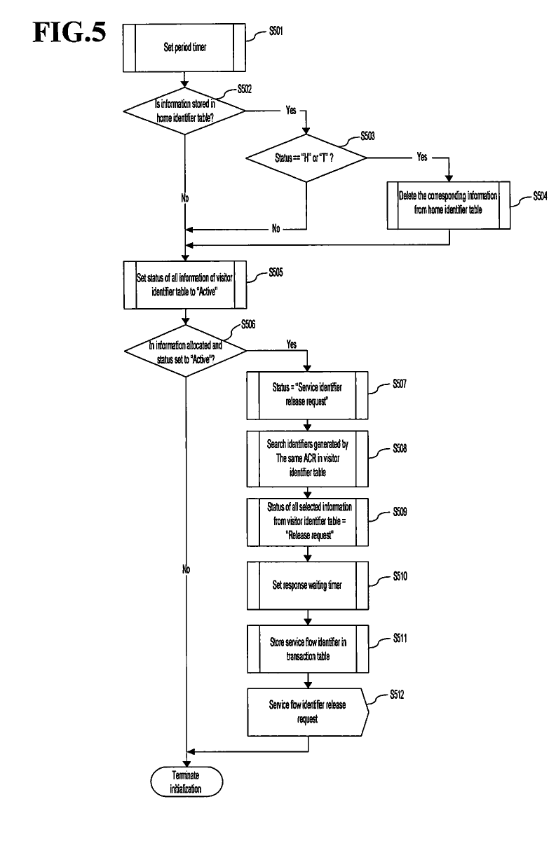

FIG. 4A is a block diagram of the home identifier table of the table storage unit of FIG. 2.

As shown in FIG. 4A, a home identifier table 1231 manages a service flow identifier generated by an ACR 120 in which the home identifier table 1231 is included, and manages the two least significant bytes since the ACR 120 generated the service flow identifier and thus the two most significant bytes do not need to be managed. That is, the size of a home identifier table 1231 that corresponds to a service flow identifier to be managed can be reduced.

Such a home identifier table 1231 includes a unique identifier field, a status field, and an age field, and is configured as a double-linked list data structure formed of the previous index and the next index. The double-linked list uses a unique identifier as a key for an available resource.

The double-linked list supports simple insertion of information on a resource having a value within a predetermined range (e.g., 0 to 65535) and efficient deletion of given information within a relatively short time.

The status field of the home identifier table 1231 has a first status value T, a second status value H, and a third status value V. The first status value T indicates that a service flow identifier is being currently allocated, and the second status value H indicates that a PSS 100 is located in a corresponding ACR 120, and the third status value V indicates that a PSS 100 allocated with a service flow identifier from a current ACR has performed handoff to another ACR and thus the service flow identifier is managed by the other ACR 120.

In addition, the home identifier table 1231 includes the age field for efficient management of service flow identifier information. A value of the age field is incremented by 1 (i.e., i++) with a constant time interval (i.e., every one minute). An error may occur when a service flow identifier is generated upon a service flow identifier generation request and the service flow identifier is allocated to the PSS 100 due to an error between the PSS 100 and the ACR 210, or an error in the radio network, and the age field is used to prevent the allocation error. The age field determines the occurrence of an error when a service identifier is not successfully allocated due to various system errors, and deletes the corresponding service flow identifier.

FIG. 4B is a schematic diagram of a visitor identifier table of the table storage unit of FIG. 2.

As shown in FIG. 4B, the visitor identifier table 1233 manages a corresponding service flow identifier when the ACR 120 allocated with a service flow identifier from another ACR 120 performs handoff to a current ACR 120.

Such a visitor identifier table 1233 includes a service flow identifier field and a status field, and uses a service flow identifier for management. In this case, the service flow identifier is managed by using a hashing method since the service identifier has a vast range.

The status field of the visitor identifier table 1231 includes an active status value, a service flow identifier release request (SFID Release_Request) status value, and a delayed status value. The active status value indicates that the corresponding service identifier is activated when the PSS 100 visits a current ACR 120 from another ACR 120, the service flow identifier release request status value indicates that a service flow identifier release request (Release_Request) message is transmitted to an ACR that has allocated the corresponding service flow identifier when the PSS 100 performs handoff to the other ACR 120 from the current ACR 120, and the delayed status value indicates that no response has been received from the corresponding ACR before time set to the response waiting timer 1253 is terminated from the service flow identifier release request status.

The home identifier table 1231 and the visitor identifier table 1233 are stored in a non-volatile memory, and therefore information relevant to service flow identifiers is not lost even though the system is restarted due to system errors.

FIG. 4C is a schematic diagram of an inactivated node table of the table storage unit of FIG. 2.

As shown in FIG. 4C, the inactivated node table 1235 manages nodes in which a corresponding ACR 120 has an error state because the ACR 120 cannot receive a response for a service flow identifier release request that has been transmitted to the corresponding ACR 120 for release of a service flow identifier stored in the visitor identifier table 1233.

Such an inactivated node table 1235 stores an ACR identifier 201 that indicates an error status node, and therefore includes only an ACR identifier field. The inactivated node table 1235 is formed by a hash table using an ACR identifier 210 as a key.

FIG. 4D is a schematic diagram of a transaction table of the table storage unit of FIG. 2.

As shown in FIG. 4D, the transaction table 1237 manages information transmitted to the corresponding ACR 120 during a process for requesting release of the corresponding service flow identifier from the corresponding ACR 120 so as to release a service flow identifier stored in the visitor identifier table 1233.

The transaction table 1237 includes an ACR identifier field, a number field, and a service flow identifier list field, and is configured as a double-linked list data structure formed of the previous index and the next index. The double-linked list uses an ACR identifier as a key.

The ACR identifier field of the transaction table 1237 stores an ACR identifier that corresponds to the ACR 120 that has received the service flow identifier release request, and the service flow identifier list field stores a release-requested service flow identifier. In this case, release of more than one service flow identifier may be requested for the same ACR 120, and therefore the service flow identifier list field stores all release-requested service flow identifiers for an ACR 120 having the same ACR identifier. The maximum number (MAX_SFID_NO) of service flow identifiers that can be stored in the service flow identifier list field is predetermined.

The number field stores a total number of service flow identifiers stored in the service flow identifier list. Therefore, a number of values stored in the number field cannot be greater than the maximum number MAX_SFID_NO.

A service flow identifier management method according to an exemplary embodiment of the present invention will be described in more detail with reference to FIG. 5 to FIG. 12.

A service flow identifier management operation performed when an ACR 120 is initialized will now be described with reference to FIG. 5.

When the ACR 120 is initialized, the service flow identifier manager 1260 sets the period timer 1251 included in the timer 1250 to periodically set information on each service flow identifier to be the same so as to prevent the service flow identifiers between ACRs from having different information from each other due to system errors, in step S501.

Then, the service flow identifier manager 1260 examines the home identifier table 1231 in the table storage unit 1230 so as to check allocated information, that is, to check whether a unique identifier exists, in step S502. Existence of allocated information in the home identifier table 1231 indicates that the ACR 120 has not been started in a normal state but was restarted in an error state so that the ACR 120 is initialized. Accordingly, when there is allocation information in the home identifier table 1231, it is checked whether a value of a status field corresponding to the allocated information is set to the first state value T or the second status field H, in step S503.

When it is checked in step S503 that the value of the status field is set to the first status value T or the second status field H, the allocated information indicates that a resource is allocated to the home ACR 120 and used only within the home ACR 120, and therefore the corresponding information is deleted from the home identifier table 1231, in step S504.

However, when it is checked in step S502 that no information is allocated in the home identifier table 1231 or the value of the status field is set to the third status field V, it is determined that the ACR 120 has been normally started, and therefore the next process is performed.

Subsequently, the visitor identifier table 1233 in the table storage unit 1230 is checked, and when there is allocated information in the visitor identifier table 1233, a status field of the allocation information is set to an “Active” status value, in step S505.

After that, the service flow identifier manager 1260 checks whether allocated information exists in the visitor identifier table 1233, and the value of the status field of the corresponding information is set to an “Active” status value, in step S506. When there exists allocated information in the visitor identifier table 1233 and the value of the status field of the corresponding information is set to “Active”, it is determined that the ACR 120 has been restarted in the error state and thus a value of a status field of the corresponding information is set to the “service flow identifier release request” value in step S507, and then information allocated from an ACR that is the same of the ACR that has allocated the information to be deleted among information allocated in the visitor identifier table 1233 are searched, and a value of a status field of the searched information is set to the “service flow identifier release request” value, in step S509.

Subsequently, the response waiting timer 1253 of the timer 1250 is set in step S510, and the information searched in steps S507 and S509 is stored in the transaction table 1237, in step S511. In this case, the ACR identifier field of the transaction table 1237 stores an ACR identifier for an ACR that has allocated the searched information, the service identifier list field stores all service flow identifiers of the searched information, and the number field stores the number of searched information, that is, the number of service flow identifiers stored in the service flow identifier list fields.

The service flow identifier manager 1260 transmits a service flow identifier release request (SFID Release_Request) message to the ACR that has allocated the searched information so as to release service flow identifiers of the searched information, in step S512.

Completion responses for the service flow identifier release request messages that have been transmitted in step S512 are received from the corresponding ACR within a time that has been set in step S510 to the response waiting timer 125, and all initialization processes are terminated. When a completion response is not received from the corresponding ACR 120 within the set time of the response waiting timer 1253, it implies that the corresponding ACR is not in the normal state, and therefore the next process must be performed so as to set a status of each of the release-requested service flow identifiers to be the same. The next process will be described in further detail later.

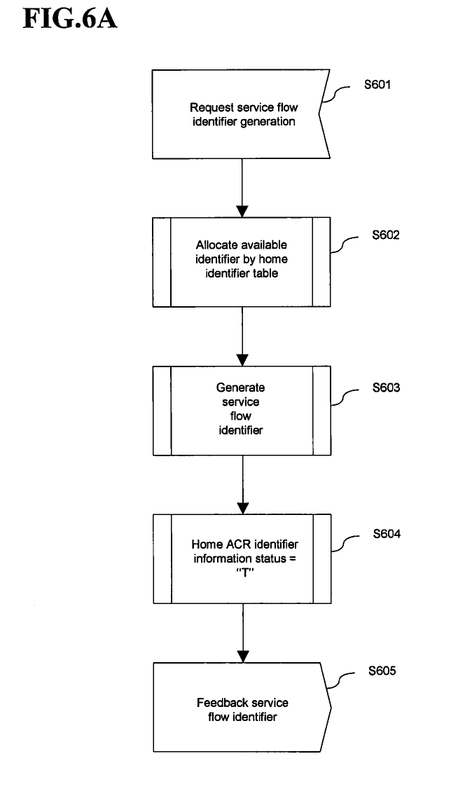

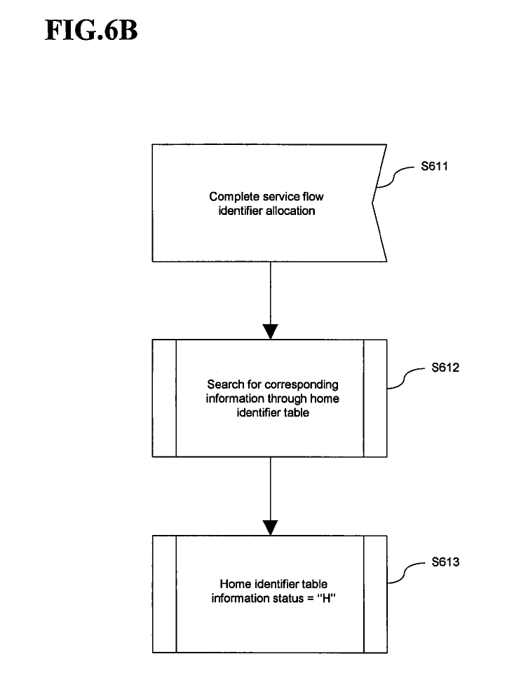

A method for generating a service flow identifier in an ACR 120 of a wireless communication system and allocating the service flow identifier to a mobile terminal according to the exemplary embodiment of the present invention will be described with reference to FIG. 6A and FIG. 6B.

In general, messages related to connection establishment include a dynamic service addition (DSA) message, a dynamic service change (DSC) message, and a dynamic service deletion (DSD) message.

Such a message related to the connection establishment may be started from the PSS 100 or may be started from the ACR 120. Assume that the PSS 100 starts the message, for convenience of description.

As shown in FIG. 6A, when the service flow identifier manager 1260 receives a service flow identifier generation request message from the PSS through the PSS-side interface 1210 in step S601, an available (idle) unique identifier 202 is selected from the home identifier table 1231 through the table manager 202 and allocated in step S602, and then a service flow identifier is generated by connecting a corresponding index to an ACR identifier 201 of the selected unique identifier, in step S603.

The service flow identifier manager 1260 sets a status of the unique identifier 202 allocated from the home identifier table 1231 to the first status value T to indicate that a service flow identifier is being allocated, in step S604, and the generated service flow identifier is fed back and allocated to the PSS 100 that has transmitted the generation request message, in step S605.

As shown in FIG. 6B, when the service flow identifier manager 1260 receives a service flow identifier allocation completion message from the PSS 100 through the PSS-side interface 1210 in step S611, information in the home identifier table 1231 is searched by using a unique identifier 202 of the service flow identifier as an index in step S612, and then a status field value of the corresponding home identifier table 1231 is set to the second status value H in step S613.

Through the above-state processes, a service flow identifier allocation operation to the PSS 100 is completed.

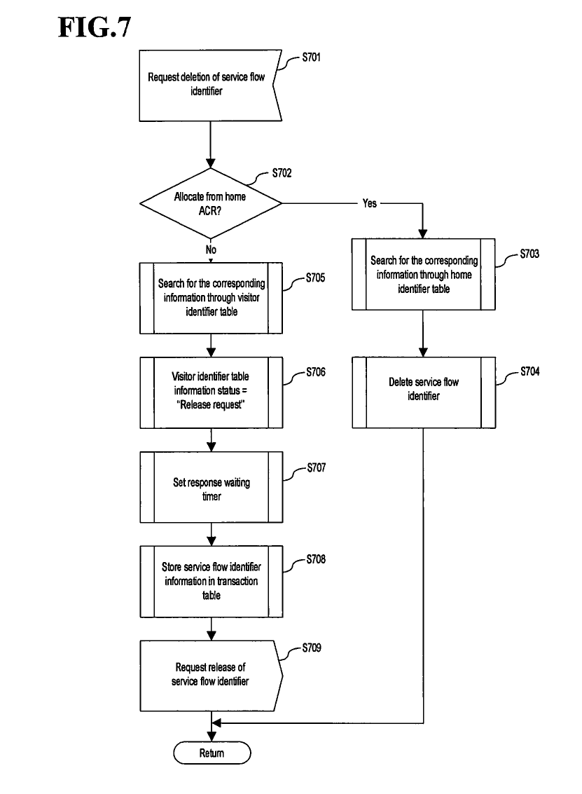

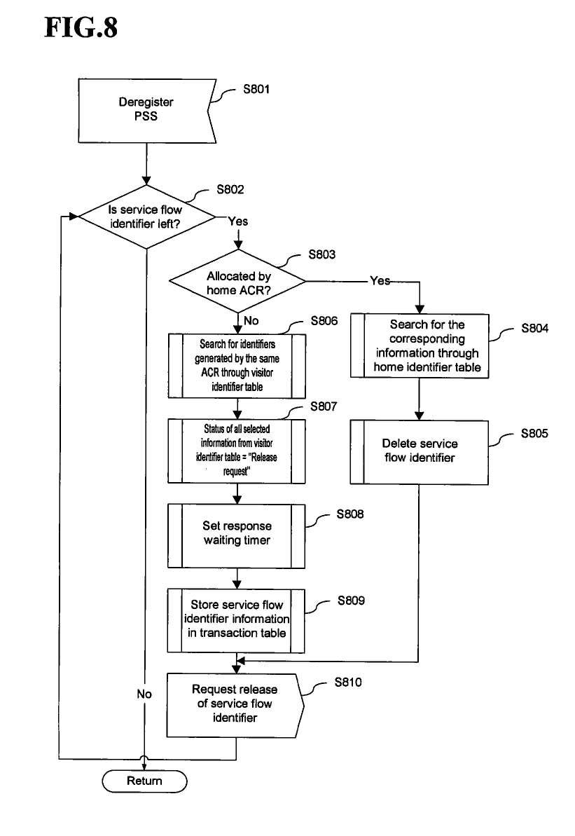

A process for deleting a service flow identifier will be described with reference to FIG. 7.

When the service flow identifier manager 1260 of the ACR 120 receives a service flow identifier deletion request message through the PSS-side interface 1210 in step S701, an ACR identifier 201 of the deletion-requested service flow identifier is searched so as to determined whether the deletion-request service flow identifier is allocated by an ACR (hereinafter referred to as a “home ACR”) 120 in which the service flow identifier is located or by another ACR 120, in step S702.

When the service flow identifier is allocated by the home ACR, the service flow identifier manager 1260 searches through the home identifier table 1231 by using a unique identifier 202 as a key through the table manager 1240 in step S703, and a searched unique identifier 202 is deleted from the home identifier table 1231 such that deletion of the corresponding service flow identifier is completed in step S704.

When the service flow identifier is allocated by the other ACR, the service flow identifier manager 1260 searches through information in the visitor identifier table 1233 with reference to an ACR identifier 201 or the service flow identifier through the table manager 1240 in step S705, and a status field of a service flow identifier of the searched visitor identifier table 1233 is set to the “service flow identifier release request (SFID Release_Request)”, in step S706.

Subsequently, the response waiting timer 1253 of the timer 1250 is set in step S707, and information on the deletion-requested service flow identifier is stored in the transaction table 1237 in step S708. In this case, the ACR field of the transaction table 1237 stores an ACR identifier for identifying an ACR that has allocated the deletion-requested service flow identifier, and the number field stores the number of service flow identifiers stored in the service flow identifier list field. That is, a value stored in the number field is 1.

The service flow identifier manager 1260 transmits a service flow identifier release request message to the ACR that has allocated the deletion-requested service flow identifier, in step S709.

When a completion message for the service flow identifier release request message transmitted in step 709 is received within a time set in step S707 to the response waiting timer 1253 from the corresponding ACR, the service flow identifier release process is completed. However, when the completion message is not received within the time set to the response waiting timer 1253 from the corresponding ACR, it implies that the ACR is not in the normal state and therefore the next process must be performed to set a status of each of the deletion-requested service flow identifiers to be the same. The next process will be described in further detail later.

A service flow identifier deletion process performed when releasing registration of a PSS 100 will be described with reference to FIG. 8.

When a home ACR receives a de-registration request message from a PSS 100 and thus a service flow identifier deletion request is received through the PSS-side interface 1210 in step S801, the service flow identifier manager 1260 determines whether remaining service identifiers exist for the corresponding PSS 100 in step S802.

When any service flow identifier of the de-registration-requested PSS 100 is allocated by the home ACR in step S803, the service flow identifier manager 1260 searches through the home identifier table 1231 through the table manager 1240 by using a unique identifier 202 of the home identifier table 1231 as a search key in step S804, and deletes the searched unique identifiers 202 from the home identifier table 1231 such that the process for deletion of the corresponding service flow identifiers are completed in step S805.

When the service flow identifier of the de-registration-requested PSS 100 is allocated not by the home ACR but by another ACR, the service flow identifier manager 1260 searches for all service flow identifiers allocated by the same ACR through the visitor identifier table 1233 with reference to an ACR identifier 201 of the service flow identifier in step S806, and a value of a status field of each of the searched service flow identifiers of the visitor identifier table 1233 is set to the “service flow identifier release request (SFID Release_Request)” value in step S807.

After setting the response waiting timer 1253 of the timer 1250 in step S808, information on the deletion-requested service flow identifiers are sent to the transaction table 1237 in step S809. In this case, the ACR field of the transaction table 1237 stores an ACR identifier that identifies an ACR that has allocated the deletion-requested service flow identifiers, the service flow identifier list field stores the maximum number MAX_SFID_NO of the deletion-requested service flow identifiers, and the number field stores the number of service flow identifiers stored in the service flow identifier list field.

Subsequently, the service flow identifier manager 1260 transmits a service flow identifier release request SFID Release_Request message to the ACR that has allocated the deletion-requested service flow identifiers, in step S810.

When a completion message is received within the set time of the response waiting timer 1253 in response to the service flow identifier release request message transmitted in step S810, all PSS de-registration processes are completed. However, when the completion message is not received within the set time of the response waiting timer 1253, it is determined that the corresponding ACR is in the error state, and therefore the next process must be performed to set a status of each of the deletion-requested service flow identifiers to be the same. The next process will be described in further detail later.

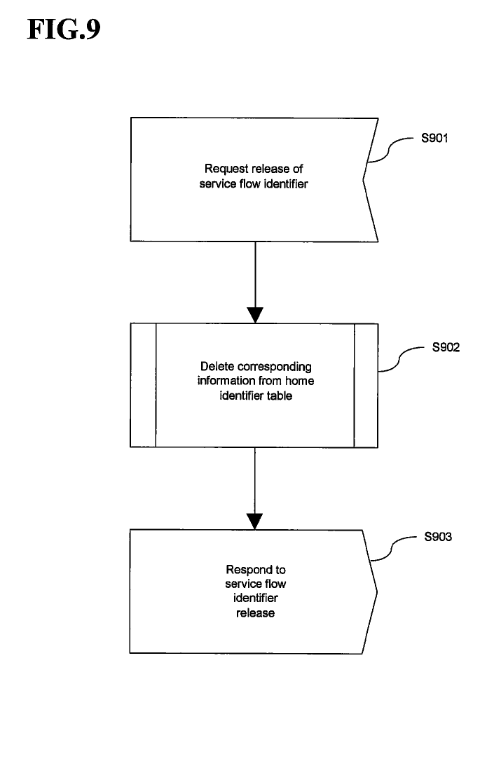

A process for deleting the corresponding service flow identifier in response to a service flow identifier release request message will be described with reference to FIG. 9.

When a home ACR that has allocated service flow identifiers receives a service flow identifier release request message from another ACR in step S901, the service flow identifier manager 1260 searches for the corresponding information through the home identifier table 1231 by using a unique identifier 202 of the deletion-requested service flow identifier as a search key, and deletes the searched information in step S902. The service flow identifier manager 1260 transmits a response message to the ACR that has transmitted the release request message such that the deletion process for the separately managed service flow identifier is completed in step S903.

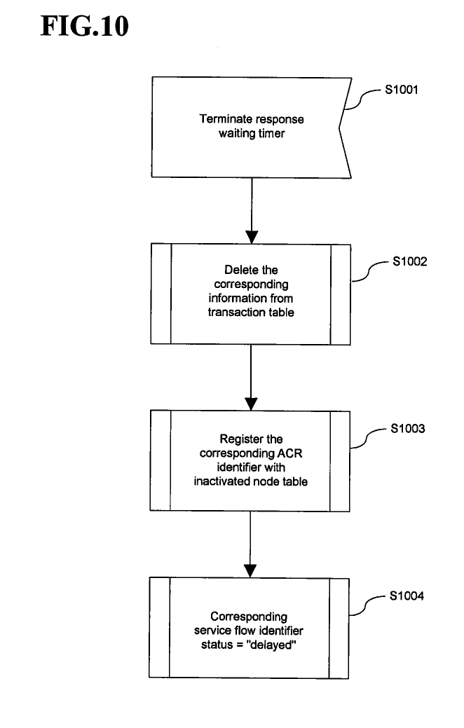

A method for managing a service flow identifier when the set time of the response waiting timer 1253 is terminated will be described with reference to FIG. 10.

When the time of the response waiting timer 1253 set in step S520 of FIG. 5, in step S707 of FIG. 7, and in step S808 of FIG. 8 is terminated in step S1001, the service flow identifier manager 1260 of the home ACR searches through the transaction table 1237 and deletes the corresponding transaction information related to the time setting of the response waiting timer 1253, in step S1002. In addition, an ACR identifier of an ACR that has not transmitted a response until the set time of the response waiting timer 1253 is terminated is registered with the inactivated node table 1253 in step S1003, and a value of a status field of the corresponding service flow identifier in the visitor identifier table 1233 to “delayed” status value in step S1004.

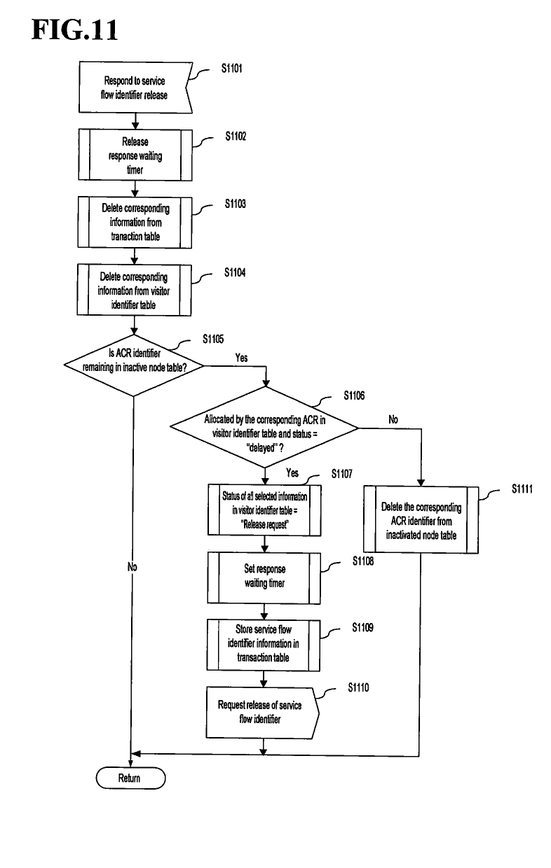

A method for managing a service flow identifier when a response message for a service flow identifier release request is received will be described with reference to FIG. 11.

When the service flow identifier manager 1260 of the home ACR receives a service flow identifier release response message from another ACR through the ACR-side interface 1220 in step S1101, the response waiting timer 1253 is released in step S1102 and information on the responded-service flow identifier is deleted from the transaction table in step S1103. In addition, information on all of the responded-service flow identifiers are searched through the visitor identifier table 1233, and the corresponding information is deleted in step S1104.

Subsequently, it is checked whether an ACR identifier of the responded-ACR is left in the inactivated node table 1235 in step S1105. When an ACR identifier of the corresponding ACR is left in the inactivated node table 1235, it implies that the corresponding ACR is changed to a normal state from an error state, and therefore information on service flow identifiers that are allocated by the corresponding ACR and have a status field value set to the “delayed” status value are searched from the visitor identifier table 1233, in step S1106. In this case, the number of the searched information is set to be less than the maximum number MAX_SFID_NO for a deletion process.

When service flow identifier are searched in step S1106, status fields of the searched service flow identifiers are set to “service flow identifier release request” status value in step S1107, the response waiting timer 1153 is set in step S1108, and the searched flow identifier information are stored in the transaction table 1237, in step S1109.

After that, the service flow identifier manager 1260 transmits a service flow identifier release request SFID Release_Request message to the ACR that has allocated the searched service flow identifiers so as to release the searched service flow identifier, in step S1110.

When a completion response for the service flow identifier release request message transmitted in step S1110 is received within the set time of the response waiting timer 1253 from the corresponding ACR in step S1108, the corresponding service flow identifier release process is completed.

When no service flow identifier is searched in step S1106, this implies that the process for equalizing information on all the separately managed service flow identifiers is completed after the ACR registered with the inactivated node table 1235 is changed to the normal state from the error state, and therefore an ACR identifier of the corresponding ACR is deleted from the inactivated node table 1235, in step S1111.

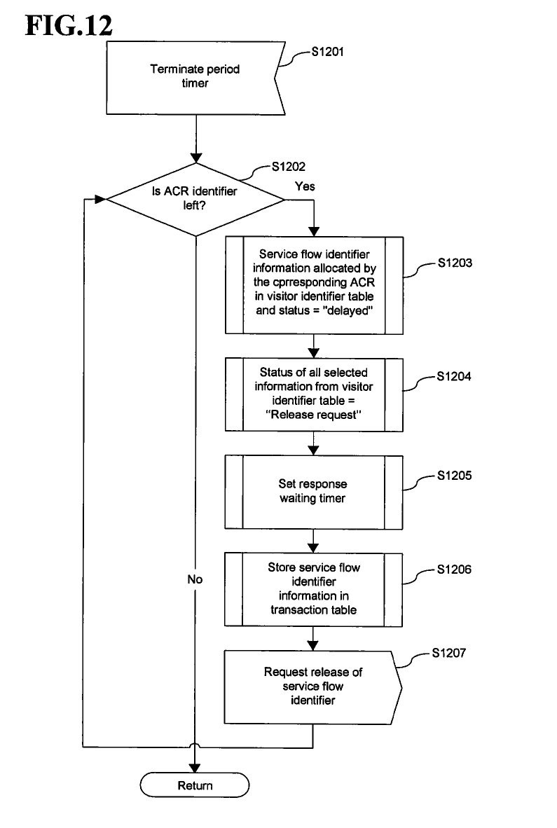

A method for managing service flow identifiers when the period timer 1252 is terminated will be described with reference to FIG. 12.

When the period timer 1251 used for equalizing information of service flow identifiers is terminated in step S1201, the service flow identifier manager 1260 checks whether remaining ACR identifiers exist in the inactivated node table 1235 in step S1202.

The existence of remaining ACR identifiers implies that at least one ACR not having the same service flow identifier information exists, and therefore service flow identifiers having been allocated by the corresponding ACR and having status values set to the “delayed” status value are searched through the visitor identifier table 1233 in step S1203. In this case, the number of searched service flow identifiers is set to less than the maximum number MAX_SFID_NO for a deletion process.

A status field value of the searched service flow identifier is set to the “service flow identifier release request” status value in step S1204, the response waiting timer 1153 is set in step S1205, and the searched service flow identifiers are stored in the transaction table 1237 in step S1206.

Subsequently, the service flow identifier manager 1260 transmits a service flow identifier release request (SFID Release_Request) message to an ACR that has allocated the searched service flow identifiers for releasing the searched service flow identifiers, in step S1207.

When a completion response for the service flow identifier release request message transmitted in step S1207 is received from the corresponding ACR within the time of the response waiting timer 1235 set in step S1205, the corresponding service flow identifier release process is completed.

As described above, an ACR 120 separately manages service flow identifiers of each PSS 100 by using the home identifier table 1231 and the visitor identifier table 1233 so that information on each service flow identifier can be separately managed by a plurality of ACRs 120.

In addition, when separately managing service flow identifiers between the plurality of ACRs, the response waiting timer 1253, the inactivated node table 1237, and the transaction table 1237 are used to prevent information on each service flow identifier from being different from each other.

As described, in a wireless communication system, particularly in the portable Internet system, an ACR manages service flow identifiers of each PSS by using a separated control method so as to prevent information on each of the separately managed service flow identifiers from being different from each other, thereby reducing the number of control messages compared to a central control method and remarkably reducing occurrence of errors in the system.

As described above, in the wireless communication system, the plurality of ACRs separately manage service flow identifiers, and mismatched service flow identifier information due to errors in the system or a node or message transmission/receiving errors can be set to be the same.

In addition, when a partial system error occurs and thus the system is restored, some service flow identifiers not having the same status due to the error can be efficiently released and set to be the same.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A wireless communication system comprising:
a plurality of radio access stations (RASs) for controlling a plurality of portable subscriber stations (PSSs) in a radio network; and
a plurality of access control routers (ACRs) for providing wireless communication services to the PSSs through the plurality of RASs, and respectively managing service flow identifiers used for identifying a connection service for each PSS,
wherein when a status of each service flow identifier managed by the plurality of ACRs is different, the wireless communication system releases the corresponding service flow identifier so as to set the status of each of the service flow identifiers managed by the ACRs to be the same.

2. The wireless communication system of claim 1, wherein each of the plurality of ACRs separately manage a service flow identifier generated by the ACR and a service flow identifier generated by another ACR among service flow identifiers of a PSS that is visiting a service area of the ACR.

3. The wireless communication system of claim 2, wherein, when deleting a service flow identifier generated by another ACR among service flow identifiers managed by each of the ACRs, the ACR requests deletion of the corresponding service flow identifier from an ACR that has generated the service flow identifier.

4. The wireless communication system of claim 1, wherein each of the plurality of ACRs comprises:
a PSS-side interface for providing an interface through which a service flow identifier message is communicated with a PSS through the RAS;
an ACR-side interface for providing an interface through which a service flow access control message is communicated with another ACR for a PSS that has performed handoff between ACRs;
a table storage unit for storing information used for separate management of service flow identifiers by the ACR;
a table manager for performing operations related to generation of a service flow identifier, change of a service flow identifier status, deletion of a service flow identifier, and equalization of a status of each service flow identifier by managing information stored in the table storage unit;
a timer for measuring time used for setting a status of each of service flow identifiers that are separately managed between the plurality of ACRs to be the same; and
a service flow identifier manager for controlling the PSS-side interface, the ACR-side interface, the table manager, and the timer so as to set the status of each of the service flow identifiers that are separately managed between the plurality of ACRs to be the same.

5. The wireless communication system of claim 4, wherein the service flow identifier comprises:
an ACR identifier for identifying an ACR that has generated the service flow identifier; and
a unique identifier having a unique value in an ACR identified by the ACR identifier.

6. The wireless communication system of claim 4, wherein the table storage unit comprises:
a home identifier table for storing and managing a service flow identifier generated by the ACR;
a visitor identifier table for storing and managing a service flow identifier generated by another ACR among service flow identifiers of a PSS that has performed handoff to a home ACR from the other ACR,
an inactivated node table for storing information on another ACR that manages a service flow identifier whose status is not the same as that of a service flow identifier managed by the home ACR due to an error; and
a transaction table for managing information transmitted during a service flow identifier release process performed to set a status of each service flow identifier to be same.

7. The wireless communication system of claim 6, wherein the home identifier table comprises:
a unique identifier field having a unique value in the ACR;
a status field for identifying status information on a unique identifier stored in the unique identifier field; and
an age field being incremented by one with a constant interval so as to prevent an error from occurring during generation of a service flow identifier,
wherein the home identifier table is configured as a double-linked list formed on the previous index and the next index and using the unique identifier field as a key for an available resource.

8. The wireless communication system of claim 7, wherein the status field comprises:
a first status value (T) for indicating that a service flow identifier that corresponds to a value of the corresponding unique identifier field is allocated to a PSS;
a second status value (H) for indicating that the PSS allocated with the service flow identifier that corresponds to the value of the corresponding unique field value is located in the home ACR; and
a third status value (V) for indicating that the PSS allocated with the service flow identifier corresponding to the value of the corresponding unique identifier field has performed handoff to another ACR.

9. The wireless communication system of claim 6, wherein the visitor identifier table comprises:
a service flow identifier field having a value corresponding to a service flow identifier generated by another ACR among service flow identifiers of the PSS that has performed handoff to the home ACR from the other ACR; and
a status field for indicating status information of a service flow identifier stored in the service flow identifier field,
wherein the visitor identifier table uses a hash table using a service flow identifier as a key.

10. The wireless communication system of claim 9, wherein the status field comprises:
a service flow identifier release request status for indicating that deletion of the corresponding service flow identifier is requested to an ACR that has generated the service flow identifier so as to delete a service flow identifier stored in the corresponding service flow identifier field;
an activated status for indicating that a service flow identifier stored in the corresponding service flow identifier field is activated; and
a delayed status for indicating that a response is not received from the corresponding ACR until a set time of the timer is terminated in the service flow identifier release request status.

11. The wireless communication system of claim 6, wherein the inactivated node table comprises an ACR identifier field corresponding to a service flow identifier whose status is not the same as that of a service flow identifier managed by the home ACR due to an error, and the inactivate node table corresponds to a hash table using an ACR identifier as a key.

12. The wireless communication system of claim 4, wherein the timer comprises:
a period timer for measuring time so as to periodically set a status of each of service flow identifiers that are separately managed by the plurality of ACRs to be the same; and
a response waiting timer for measuring time so as to determine the corresponding ACR to be an error-occurred node when a response for a service flow identifier release request for equalization of the statuses of the respective service flow identifiers is not received.

13. A method for managing a service flow identifier, the method comprising:
when a home access control router (ACR) that provides wireless communication services to a portable subscriber station (PSS) through a radio access station (RAS) is initialized, determining whether the home ACR is restarted in an error state; and
when it is determined that the home ACR is restarted in the error state, deleting a service flow identifier of a PSS located in a service area of the home ACR, wherein the service flow identifier is used for identifying a connection service for a PSS.

14. The method of claim 13, wherein, in the determining of the restart of the home ACR, it is determined that the home ACR is restarted in the error state when a PSS having a service flow identifier that has been generated by the home ACR is determined to be located in the service area of the home ACR.

15. The method of claim 13, wherein, in the determining of the restart of the home ACR, it is determined that the home ACR is restarted in the error state when a PSS having a service flow identifier that has been allocated by another ACR is determined to be located in the service area of the home ACR.

16. The method of claim 15, wherein the deleting of the service flow identifier comprises:
setting a response waiting timer for setting a response waiting time;
storing information on the service flow identifier allocated by the another ACR; and
requesting release of the service flow identifier from the other ACR.

17. The method of claim 16, further comprising:
after the requesting of the release of the service flow identifier,
deleting information on the service flow identifier stored in the storing of the information on the service flow identifier when a response to the release request is not received from the other ACR until the response waiting time set to the response waiting timer is terminated;
registering the other ACR as an error status node; and
setting a status of the service flow identifier to a deletion delayed status.

18. The method of claim 16, comprising:
after requesting release of the service flow identifier,
releasing the set response waiting timer when a response to the release request is received from an ACR that has allocated the service flow identifier before the response waiting time set to the response waiting timer is terminated;
deleting information on the service flow identifier stored in the storing of the information;
deleting the service flow identifier among service flow identifiers allocated by the other ACR;
checking whether the other ACR is registered as an error status node; and
when the other ACR is registered as the error status node, requesting the other ACR to release another service flow identifier allocated by the other ACR.

19. The method of claim 18, wherein the service flow identifier that has been requested to be released by the other ACR is a service flow identifier that is not deleted by at least one release request due to an error status of the another ACR.

20. The method of claim 17, wherein the determining of the restart of the home ACR comprises:
setting a period timer for setting a periodic time;
when the time set to the period timer is terminated,
checking whether the other ACR is registered as an error status node; and
when the other ACR is registered as the error status node, requesting the other ACR to release another service flow identifier allocated by the other ACR.

21. The method of claim 20, wherein the other service flow identifier requested to be released by the other ACR is a service flow identifier that is not deleted by at least one release request due to an error of the other ACR.

22. A method for managing a service flow identifier, the method comprising:
receiving, by a home access control router (ACR), a request for releasing a service flow identifier allocated by another ACR, the ACR providing wireless communication services to a portable subscriber station (PSS) through a radio access station (RAS);
setting a response waiting timer for setting a response waiting time;
storing information on a service flow identifier allocated by the other ACR; and
requesting release of the service flow identifier from the other ACR.

23. The method of claim 22, further comprising:
after requesting the release of the service flow identifier,
deleting the service flow identifier stored in the storing of the information of the service flow identifier when a response to the release request is not received from the other ACR before the response waiting time set to the response waiting timer is terminated;
registering the other ACR as an error status node; and
setting a status of the service flow identifier to a deletion delayed status.

24. The method of claim 22, comprising:
after the requesting of the release of the service flow identifier,
releasing the response waiting timer when a response to the release request is received from the other ACR before the response waiting time set to the response waiting timer is terminated;
deleting the information on the service flow identifier stored in the storing of the information of the service flow identifier;
deleting the service flow identifier among service flow identifiers allocated by the other ACR;
checking whether the other ACR is registered as an error status node; and
when the other ACR is registered as the error status node, requesting release of a service flow identifier allocated by the other ACR from the other ACR.

25. A method for managing a service flow identifier, the method comprising:
receiving, by a home access control router (ACR), a deregistration request from a portable subscriber station (PSS), the ACR providing wireless communication services to the PSS through a radio access station (RAS);
setting a response waiting timer for setting a response waiting time;
storing information on a service flow identifier of the PSS; and
requesting release of the service flow identifier from another ACR allocating the service flow identifier of the PSS.

26. The method of claim 25, further comprising:
after the requesting of the release of the service flow identifier,
deleting the service flow identifier information stored in the storing of the information on the service flow identifier when a response to the release request is not received before the response waiting time set to the response waiting timer is terminated;
registering the other ACR as an error status node; and
setting a status of the service flow identifier to a deletion delayed status.

27. The method of claim 25, comprising:
after the requesting of the release of the service flow identifier,
releasing the response waiting timer when a response to the release request is received from the other ACR before the response waiting time set to the response waiting timer is terminated;
deleting the service flow information stored in the storing of the information of the service flow identifier information;
deleting the service flow identifier among service flow identifiers of the PSS;
checking whether the other ACR is registered as an error status node; and
when the other ACR is registered as the error status node, requesting release of another service flow identifier of the mobile terminal from the other ACR.
